(19) United States
(12) Patent Application Publication
(10) Pub. No.: US 2017/0113559 A1
(43) Pub. Date: Apr. 27, 2017

(54) METHOD FOR CHARGING OR DISCHARGING A VEHICLE BATTERY

(71) Applicant: Dr. Ing. h.c. F. Porsche Aktiengesellschaft, Stuttgart (DE)

(72) Inventors: Thomas Kristof, Karlsruhe-Palmbach (DE); Dirk Herke, Kirchheim unter Teck (DE)

(21) Appl. No.: 15/289,549

(22) Filed: Oct. 10, 2016

(30) Foreign Application Priority Data
Oct. 21, 2015 (DE) 102015117892.3

(51) Int. Cl. B60L 11/18

(52) U.S. Cl. CPC B60L 11/1809

(57) ABSTRACT

A method for charging and/or discharging a vehicle battery using a multiphase transformer, in particular using a direct voltage transformer, wherein an input voltage is transformed into an output voltage with the multiphase transformer, wherein the multiphase transformer is operated with a permanently set transmission ratio, and the input voltage is varied in order to adapt the output voltage.

### CROSS-REFERENCE TO RELATED APPLICATIONS

This application claims priority to German Patent Application No. DE 10 2015 117 892.3, filed Oct. 21, 2015, which is incorporated by reference herein in its entirety.

### FIELD OF THE INVENTION

The present invention relates to a method for charging or discharging a vehicle battery.

### BACKGROUND OF THE INVENTION

The use of vehicle batteries for supplying an electric motor or other vehicle components is sufficiently known. In particular in the case of vehicles which are driven with an electric motor it is generally necessary here to charge the vehicle battery, mostly with the aid of a corresponding external charging station. It is necessary here that a voltage for charging has a specific set point value and is higher than a voltage of the vehicle battery. A voltage difference which arises here between the charging station and the vehicle battery defines a current and therefore a charging speed of the charging process.

Methods are known from the prior art in which voltage transformers are used, on the one hand, to transform an input voltage into an output voltage which is raised compared to the input voltage, in order to make available this raised output voltage to the vehicle battery, and, on the other hand, to ensure, through variation of the transmission ratio, that the voltage which is required by the vehicle battery is adapted to. In this context, filters are typically used in order to counteract undesired effects.

### SUMMARY OF THE INVENTION

An object of the present invention is to make available a method with which the charging or discharging of a vehicle battery is improved. In this context it would be, in particular, desirable that a device which is used for the transformation of voltages is optimized in respect of weight and installation space.

The object of the present invention is achieved by means of a method for charging and/or discharging a vehicle battery by means of a multiphase transformer, in particular by means of a direct voltage transformer, wherein an input voltage is transformed into an output voltage with the multiphase transformer, wherein the multiphase transformer is operated with a permanently set transmission ratio, and the input voltage is varied in order to adapt the output voltage.

In contrast to the prior art, the output voltage is adapted as required by varying the input voltage, with the result that it is no longer necessary to operate the multiphase transformer outside its efficiency-optimized working range. As a result, it is advantageously possible to dispense with additional filters which are intended to counteract undesired effects if the voltage transformer is operated outside its efficiency-optimized working point, as a result of which the multiphase transformer can be configured such that it requires less installation space and is lighter in weight compared to such transformers with filters. In particular, an efficiency-optimized working range is understood here to be a range in which a ripple current disappears or is below a threshold value.

In particular, there is provision that the permanently set transmission ratio is defined by means of a pulse duty factor in the multiphase transformer. Here, the defined pulse duty factor, that is to say the permanently set transmission ratio, depends in particular on the order of the multiphase transformer, i.e. the transmission ratio or ratios which can be defined differ for a 2-phased, 3-phased or m-phased voltage transformer. Furthermore, there is provision that the multiphase transformer is integrated together with the vehicle battery into a vehicle.

According to a further embodiment of the present invention it is provisioned that the input voltage is limited to a permitted input voltage range, wherein the multiphase transformer is preferably operated with input voltages from the permitted input voltage range in the region of an efficiency-optimized working point of the multiphase transformer.

According to a further embodiment of the present invention it is provisioned that in order to expand the permitted input voltage range a plurality of efficiency-optimized working points are made available by the multiphase transformer. In particular it is provisioned to increase the number of possible permanently settable transmission ratios or pulse duty factors for which there is an efficiency-optimized working point by increasing the order. In this context it is conceivable that the input voltage ranges assigned to the respective transmission ratios overlap, with the result that the broadest possible spectrum of potentially useful input voltages is advantageously made available. In particular, there is no restriction to a comparatively small input voltage range as is the case for a 2-phase transformer.

According to a further embodiment of the present invention it is provisioned that changing occurs between fixed transmission ratios, in particular during a charging or discharging process. As a result, the broadest possible spectrum of input voltages for the adaptation or modification of the output voltage can be advantageously used during the entire charging or discharging process.

According to a further embodiment of the present invention it is provisioned that communication is carried out, by means of an output-voltage-side, in particular vehicle-side, charge management system, with an input-voltage-side, in particular charging-station-side, control device for setting the input voltage. As a result of this communication it is advantageously possible to adapt the input voltage as a function of the required output voltage and therefore ensure that the desired and required output voltage is obtained. Furthermore, the order of the multiphase transformer or the specifications thereof can be communicated to the input-side control device. It is conceivable, in particular, that the communication takes place in a wireless fashion.

According to a further embodiment of the present invention it is provisioned that the multiphase transformer is used
(a) to charge a battery by means of a charging station,
(b) for the vehicle-internal supply of a vehicle component by means of the vehicle battery and/or
(c) for feeding back into the supply system.

In particular, the multiphase transformer can be used here for discharging or charging the vehicle battery.

A further subject matter of the present invention is a charging station for charging a vehicle battery with a method according to aspects of the invention, wherein the charging station has a control device for making available a variable input voltage for the multiphase transformer.

A further subject matter of the present invention is a system composed of a charging station and a vehicle comprising a vehicle battery and a multiphase transformer, wherein the charging station and the vehicle are configured to carry out the method according to aspects of the invention.

### BRIEF DESCRIPTION OF THE DRAWINGS

Further details, features and advantages of the invention can be found in the drawings and in the following description of preferred embodiments, with reference to the drawings. The drawings illustrate here merely exemplary embodiments of the invention which do not restrict the essential inventive concept.

FIGS. 1a and 1b show the dependence of a normalized input current (FIG. 1a) and of a ripple current (FIG. 1b) on the pulse duty factor of a multiphase transformer in the case of a single-phased transformer, two-phased transformer and three-phased transformer.

FIG. 2 shows a block diagram of a method according to a first exemplary embodiment of the present invention.

FIG. 3 shows a block diagram of a method according to a second exemplary embodiment of the present invention.

FIG. 4 shows a block diagram of a method according to a third exemplary embodiment of the present invention.

### DETAILED DESCRIPTION OF THE INVENTION

In the various figures, identical parts are always provided with the same reference symbols and are therefore generally also each specified or mentioned only once.

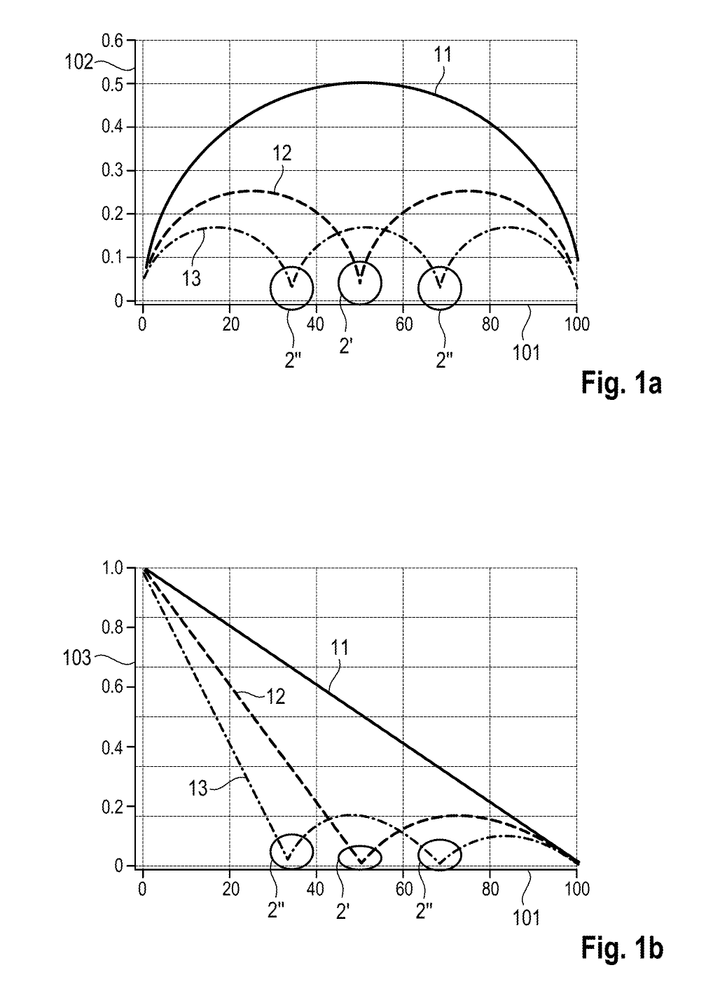

In FIGS. 1a and 1b, a normalized input current 102 (FIG. 1a) which is to be set at the filter capacitor and a normalized ripple current 103 (FIG. 1b) which is to be set at the output are each illustrated as a function of the pulse duty factor 101 of a multiphase transformer 1, in particular in the case of a two-phased transformer 12 and a three-phased transformer 13 as well as a single-phased transformer 11. Here, the pulse duty factor 101 is specified as a percentage. In particular, the multiphase transformer 1 is provided for transforming, for example, during the charging of a vehicle battery 3, an input voltage into an output voltage which is raised compared to the input voltage. In this context, the pulse duty factor 101 in the case of the multiphase transformer 1 defines a transmission ratio, i.e. a ratio between the input voltage and the output voltage.

Different input currents 101 and ripple currents 102 occur as a function of the transmission ratio or pulse duty factor 101 which is set, and have to be counteracted in a costly fashion with filters. In order to avoid these filters it is provided that the transmission ratio is set, or the pulse duty factor is defined, in such a way that the multiphase transformer 1 is operated at an efficiency-optimized working point 2′, 2″. In particular, the multiphase transformer 1 assumes an efficiency-optimized working point 2′, 2″ if the ripple current 102 or input current 103 essentially disappear or assume a minimum value. In order to be able to adapt the output voltage as a function of the voltage demand of a consumer, for example the vehicle battery 3, despite the permanently set transmission ratio, there is provision, in particular, that the input voltage is varied. For this purpose it is preferably provisioned that a control device which controls the input voltage communicates with an output-voltage-side charging management system. Furthermore, it is provisioned that an m-phased multiphase transformer 1 is used, wherein m is an integer and is greater than 2. As a result, the number of possible efficiency-optimized working points 2′, 2″ is advantageously increased, and the possible input voltage range is expanded. In this context it is conceivable that the working point 2′, 2″ is implemented by a changeover between two permanently set transmission ratios during a charging process.

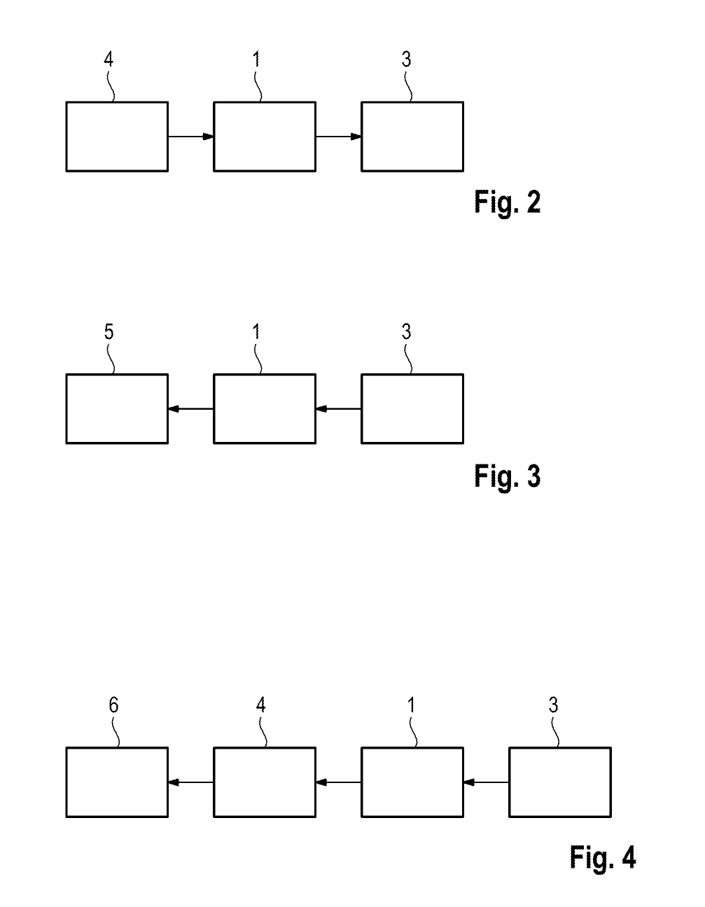

FIG. 2 is a block diagram illustrating a method according to a first exemplary embodiment of the present invention. The method is provided here for charging a vehicle battery 3 which supplies an electric motor. In particular, the input voltage (between 200 and 500 V) which is output by a charging station 4 is to be transformed into an output voltage between 400 and 900 V by means of the method. In this context it is furthermore provisioned that the multiphase transformer 1, preferably a direct voltage transformer, is integrated into the vehicle, and the vehicle battery 3 is supplied via an external charging station 4. Furthermore, it is preferably provisioned that the input voltage which is made available by the charging station 4 is variable.

FIG. 3 is a block diagram illustrating a method according to a second exemplary embodiment of the present invention. It is provisioned here that the multiphase transformer 1 is used vehicle-internal to transform an input voltage into an output voltage. In particular it is provisioned that a vehicle component 5, for example an air-conditioning compressor, is supplied by means of the vehicle battery 3 during the driving operation of the vehicle. In order to make available the voltage which is necessary for the vehicle component, the voltage which is made available by the vehicle battery 3 is preferably transformed as an input voltage by the multiphase transformer 1 and made available to the vehicle component 5 as an output voltage of the multiphase transformer 1. That is to say in the second exemplary embodiment the multiphase transformer 1 is used to discharge the vehicle battery 3.

FIG. 4 is a block diagram illustrating a method according to a third exemplary embodiment of the present invention. Here the multiphase transformer 1 is provided for feeding back energy into a supply system 6 which feeds the charging station 4. As a result, the method can advantageously also be used to cover a peak demand of a supply system 6 by feeding back energy into the supply system 6 by means of the multiphase transformer 1 is without additional expenditure on filters and in a way which is optimized in terms of efficiency.

What is claimed is:

1. A method for charging or discharging a vehicle battery using a multiphase transformer, the method comprising the steps of:
transforming an input voltage into an output voltage using the multiphase transformer,
operating the multiphase transformer with a permanently set transmission ratio, and
varying the input voltage in order to adapt the output voltage.

2. The method as claimed in claim 1, further comprising limiting the input voltages to a permitted input voltage range, operating the multiphase transformer with input voltages from the permitted input voltage range in a region of an efficiency-optimized working point of the multiphase transformer.

3. The method as claimed in claim 2, wherein in order to expand the permitted input voltage range a plurality of efficiency-optimized working points are made available by the multiphase transformer.

4. The method as claimed in claim 1, wherein changing occurs between fixed transmission ratios during either a charging or discharging process.

5. The method as claimed in claim 1, further comprising carrying out communication using an output-voltage-side charge management system, with an input-voltage-side control device for setting the input voltage.

6. The method as claimed in claim 1, wherein the multiphase transformer is used (a) to charge the vehicle battery using a charging station, (b) for the vehicle-internal supply of a vehicle component using the vehicle battery, and/or (c) for feeding back energy into a supply system of the charging station.

7. A charging station for charging the vehicle battery using the method as claimed in claim 6, wherein the charging station has a control device for making available a variable input voltage for the multiphase transformer.

8. A system comprising the charging station and the vehicle including the vehicle battery and the multiphase transformer, wherein the charging station and the vehicle are configured to carry out the method as claimed in claim 6.

9. The method as claimed in claim 1, wherein the multiphase transformer is a direct voltage transformer.
